(19) United States
(12) Patent Application Publication
(10) Pub. No.: US 2011/0108245 A1
(43) Pub. Date: May 12, 2011

(54) Circuit Board Forming Diffusion Bonded Wall of Vapor Chamber

(75) Inventors: Kia Kuang Tan, Penang (MY); Wah Sheng Teoh, Penang (MY)

(73) Assignee: DSEM HOLDINGS SDN. BHD., Penang (MY)

(21) Appl. No.: 12/941,850

(22) Filed: Nov. 8, 2010

(30) Foreign Application Priority Data
Nov. 10, 2009 (MY) PI 20094778

(51) Int. Cl. F28D 15/04; B32B 37/02; B32B 37/14; B32B 37/06; B32B 37/10

(52) U.S. Cl. 165/104.26; 156/70

(57) ABSTRACT

A method for providing a high in-plane and through-plane thermal conductivity path between a heat producing electronic device and a heat sink is described. A vapor chamber is formed of a bottom metal shell and a top plate which are diffusion bonded together at their edges. The top plate is itself a circuit board that may be a metal core type, a ceramic type, or any bondable composite material. The metal core circuit board is preferably aluminum, and the dielectric regions on its top surface are aluminum oxide regions. A metal circuit layer is formed on the dielectric regions for interconnecting electronic devices mounted on the circuit board. Since the back surface of the circuit board is directly in contact with the working fluid in the vapor chamber, there is the ultimate in thermal coupling between the circuit board and a heat sink connected to the back of the vapor chamber.

### FIELD OF THE INVENTION

This invention relates to thermal management of electronic circuits and, in particular, to a vapor chamber for providing high in-plane and through-plane thermal conductivities between an electronic device (e.g., a semiconductor chip) and a heat sink.

### BACKGROUND

High-power light emitting diodes, microprocessors, and other compact, high heat generating electronic devices need to be mounted on a thermally conductive substrate that is ultimately thermally connected to a heat sink. The best thermal path to the heat sink is through an all-metal path. However, a polymer dielectric layer typically exists between the electronic device and the heat sink for providing electrical isolation between the device electrodes and the heat sink.

To avoid the polymer dielectric layer, it is known to directly bond a copper interconnect layer to an insulating ceramic substrate (e.g., Al₂O₃ or AlN), where the electronic device is mounted on the copper interconnect layer. Then, a small-area metalized bottom surface of the ceramic substrate is soldered to a relatively large metal plate for mechanical mounting (e.g., via bolts) to a heat sink. The large metal plate helps to spread heat laterally across the heat sink for increased heat removal and provides a means for attaching the ceramic substrate to the heat sink. Such a ceramic substrate is known as a direct bonded copper (DBC) substrate, since there is no intermediate layer between the copper and the ceramic. The thermal conductivity of a thin ceramic substrate is much greater than that of a polymer layer.

In applications where there is a need for even further thermal control, the electronic device is thermally coupled to the top surface of a vapor chamber for increased spreading of heat, and the bottom surface of the vapor chamber is affixed to a heat sink. By spreading the heat, the overall thermal resistance is reduced. Vapor chambers typically provide greater than 30% more heat spreading than a solid metal plate. Heat spreaders other than a vapor chamber may be used.

A vapor chamber is a thin closed metal chamber, typically formed of copper, with flat top and bottom surfaces. The chamber contains a small quantity of a working fluid, such as water, under a partial vacuum. The chamber also contains a wick. The heat source is thermally coupled to the top surface, and the bottom surface is thermally coupled to a heat sink. The heat source vaporizes the water in the chamber near the top surface to create a phase change. The vapor is then cooled at the bottom surface and turns into a liquid. This creates a pressure differential that speeds up the movement of the liquid back to the top surface by capillary action through the wick. The flowing of the liquid/vapor inside the vapor chamber helps spreads the heat in two dimensions across the vapor chamber area (in-plane spreading) and the heat is conducted in a vertical direction (through-plane) to the heat sink. By spreading the heat over a relatively large area (compared to the size of the electronic device), the thermal resistance between the electronic device and the heat sink is reduced.

Further details of vapor chambers are described in US Publication Nos. 2006/0196640, 2007/0295486, and 2008/0040925, and U.S. Pat. No. 7,098,486, all incorporated herein by reference.

Since the vapor chamber is constructed by bonding two or more pieces of metal together, it is electrically conductive and not suitable for directly supporting electrical devices unless a dielectric layer is provided on the vapor chamber surface. Providing a dielectric layer on a vapor chamber surface includes techniques such as laminating a FR-PCB layer to the surface using a thermally conductive adhesive, depositing a liquid dielectric material such as an epoxy/resin base material on the surface, or affixing a non-electrically conductive circuit board (e.g., AlN, Al₂O₃, BeO, or other ceramic) to the surface.

FIG. 1 is a laterally compressed cross-sectional view of a typical vapor chamber with a circuit board mounted on it. The top shell 12 and bottom shell 14 of the vapor chamber are typically copper and have their edges bonded together, such as by diffusion bonding, high-temperature soldering, etc. The bonding area 16 may be solder or the merged metals diffusion-bonded together. The vapor chamber contains a wick and a working fluid.

A conventional circuit board 18 (e.g., FR-PCB, metal core printed circuit board (MCPCB), or ceramic) has a patterned metalized top surface for use as an electrical interconnection layer for electrical components that will be ultimately mounted on the circuit board. The patterned metalized surface is represented by the metal layer 20. If the circuit board 18 is a metal core, there will be a dielectric layer (typically laminated) on its top surface to insulate the metal layer 20 from the metal core.

The bottom surface of the circuit board 18 is thermally and/or mechanically fixed to the top shell 12 of the vapor chamber by a thermally conductive adhesive 22, such as solder or a thermal interface material (TIM).

A metal core printed circuit board (MCPCB) is a well known type of circuit board for use with high heat generating components to achieve good vertical thermal conductivity. However, the dielectric layer between the electrical device and the vapor chamber adds thermal resistance into the overall system. The dielectric layer must also exceed a certain minimum thickness for the voltages used. The thermal resistance is a function of material resistance and thickness of the material used.

Additionally, most of the dielectrics deposited on a circuit board or on the vapor chamber metal surface are subject to bond reliability issues due to environmental stress (heat, aging effects, moisture, etc).

If the electronic devices were first mounted on a conventional non-metal circuit board (e.g., FR4 or ceramic) and the back surface of the relatively large circuit board were somehow soldered directly to the top surface of the vapor chamber, voids in the solder layer under the board may develop due to the relatively large surface area being soldered. Typically, the board would be soldered only around the edges. Further, a solder reflow technique (typically used for surface mount devices) could not be used since it would subject the fluid in the vapor chambers to temperatures around 230° C., which exceeds the typical maximum allowable temperature for the vapor chamber. Therefore, any soldering to the vapor chamber must be done by other than surface mounting technology solder reflow.

It is also known to directly solder LED chips to the top surface of the vapor chamber (U.S. Pat. No. 7,098,486) and use the metal of the vapor chamber as an electrode, but this technique has many drawbacks, such as requiring special equipment to connect the delicate electrodes of the LEDs to other than the standard circuit board or substrate. Further, the other electrodes of the LEDs must somehow be insulated from the vapor chamber. In U.S. Pat. No. 7,098,486, the other electrodes are connected, via wires, to metal pads overlying a laminated dielectric layer. Such a dielectric layer has bonding reliability problems and has a very low thermal conductivity.

What is needed is an improved technique for thermally coupling a heat generating electronic device, such as one or more high power LEDs or a microprocessor, to a vapor chamber, where the vapor chamber is ultimately thermally coupled to a heat sink.

### SUMMARY

In one embodiment of the invention, a metal or ceramic circuit board has a metallization pattern formed on it for mounting electrical devices. A metal or ceramic circuit board has good thermal conductivity. If the circuit board is an aluminum core type, an aluminum oxide layer may be formed on the surface to provide a dielectric layer substantially co-planar with the aluminum surface. A copper layer may be printed, sputtered, plated, or otherwise deposited on the dielectric layer. If a ceramic board is used, the metallization may be formed directly on the insulating ceramic such as using direct bonding (e.g., forming a DBC substrate). No separate dielectric layer is laminated to the circuit board to avoid bonding reliability issues and reduced thermal conductivity.

The metallization is typically designed for interconnecting integrated circuit dies, LED dies, or other heat-generating components that are ultimately mounted on the metal pattern. The metal pattern may also include pads for connection to power supply leads or another board.

If the circuit board is ceramic, the bottom of the circuit board is metalized, such as with copper around its periphery. This step may be optional if the circuit board is metal.

In the prior art, the core circuit board is mounted to the top surface of the vapor chamber. In contrast, in the present invention, the bottom periphery of the circuit board itself is diffusion bonded to the bottom shell of the vapor chamber to form the vapor chamber itself. Therefore, the bottom surface of the circuit board forms an inner wall of the vapor chamber.

It is known to use solid state diffusion bonding (SSDB) to bond two metal pieces together. In SSDB, two metals are pressed together at a temperature below but near the melting points of the metals. Over time, the metal atoms of one piece diffuse into the other piece to create a very strong bond.

According to Kazakov N. F, “Diffusion Bonding of Materials,” Pergamon Press (1985, English version), diffusion bonding of materials in the solid state is a process for making a monolithic joint through the formation of bonds at the atomic level, as a result of closure of the mating surfaces due to the local plastic deformation at elevated temperature which aids interdiffusion at the surface layers of the materials being joined.

In SSDB, there are no joint discontinuities and no porosity in the joint if the mating surfaces are sufficiently polished prior to the SSDB process.

Since copper is typically used for a vapor chamber due to its high thermal conductivity, the bottom edge of the circuit board may be plated with copper to provide a copper-copper interface for the diffusion bonding. In another embodiment, different metals are diffusion bonded.

In one embodiment, the mating surfaces are first mechanically polished to provide a uniform mating surface. The SSDB process is then performed in a high vacuum at a temperature between 500°-1000° C. (preferably 700°-800° C.), and a pressure of about 500 psi (3.45 MPa) is applied to the opposing surfaces. A lower pressure may be used with a higher temperature.

In another embodiment, the mating areas of the circuit board and vapor chamber shell have deposited on them metal from the Transition Group or Post Transition Group. The mating metal can be diffusion bonded at a lower temperature than required for copper-to-copper bonding. Any metal-to-metal diffusion bonding is possible with the invention and is not restricted to only copper-to-copper bonding.

The pressure used for the diffusion bonding will typically only be applied to the periphery of the board overlying the area to be bonded, so there is little stress on the board.

After the diffusion bonding, the liquid is dispensed into the vapor chamber, under a partial vacuum, using a small pipe that is then crimped.

Using the inventive technique, the circuit board and top metallization may be formed using conventional equipment, prior to the diffusion bonding. This allows the circuit to be tested prior to being part of the vapor chamber.

After the diffusion bonding, electrical components (e.g., a die or other device) are mounted on the top of the circuit board, and the vapor chamber is thermally coupled to a heat sink, such as by providing a thermal grease between the vapor chamber and the heat sink for good thermal contact over the entire surface, then bolting the vapor chamber to the heat sink. Since the diffusion bonding process is performed prior to the electrical components being mounted on the board, there is no damage to the dies due to the high temperature and pressure.

For electrical components that have an electrically isolated thermal pad, a through-hole in the circuit board may be filled with a high thermal conductivity material, such as copper, so the copper is directly exposed inside the vapor chamber.

Accordingly, the back of the board directly conducts heat via the liquid in the vapor chamber to provide the ultimate heat conductance between any electrical component and the vapor chamber, resulting in outstanding in-plane and through-plane thermal conductance.

In one embodiment, both sides of the vapor chamber are a metal (or metal composite) circuit board or metalized ceramic board bonded together.

In one embodiment, the circuit board is made thicker than would be typically used, so as to provide wider heat spreading over the vapor chamber to avoid localized hot spots.

Diffusion bonding is not a requirement for the bond mechanism if other suitable bonds can be used.

Other embodiments are described.

### BRIEF DESCRIPTION OF THE DRAWINGS

FIG. 1 is cross-sectional view of a prior art vapor chamber on which is affixed a dielectric layer (e.g., a ceramic circuit board or an insulated metal core board) and a metallization layer. An electrical component will be mounted on the metallization layer.

FIG. 2 is a top perspective view of a vapor chamber formed in accordance with one embodiment of the invention, where the circuit board itself forms the top plate of the vapor chamber.

FIG. 3 is a back view of the vapor chamber of FIG. 2.

FIG. 4 is a front view of the vapor chamber of FIG. 2 showing in dashed outline the inner edge of the mating surface of the bottom shell, where the mating surface of the bottom shell is diffusion bonded to the bottom surface of the circuit board.

FIG. 5 is a cross-sectional view illustrating an embodiment of a top circuit board being diffusion bonded to the bottom shell of a vapor chamber. The circuit board may instead have a flat bottom surface in all embodiments.

FIG. 6 is a cross-sectional view of another embodiment of a circuit board that will be diffusion bonded to the bottom shell of a vapor chamber, where the circuit board is aluminum and an aluminum oxide layer is formed as a dielectric layer.

FIG. 7 is a cross-sectional view of another embodiment of a circuit board that will be diffusion bonded to the bottom shell of a vapor chamber, where the circuit board is aluminum and an aluminum oxide layer is formed as a dielectric layer except below a thermal pad for the electronic device.

FIG. 8 is a cross-sectional view of another embodiment of a circuit board that will be diffusion bonded to the bottom shell of a vapor chamber, where the circuit board is ceramic and the metallization is formed directly on the ceramic.

FIG. 9 is a cross-sectional view of another embodiment of a circuit board that will be diffusion bonded to the bottom shell of a vapor chamber, where the circuit board is ceramic and the metallization is formed directly on the ceramic, and where a through-hole in the board is filled with a highly conductive metal (e.g., copper) to improve thermal conductivity through the board.

FIG. 10 is a cross-sectional view illustrating a flat circuit board and different materials for the top and bottom portions of the vapor chamber.

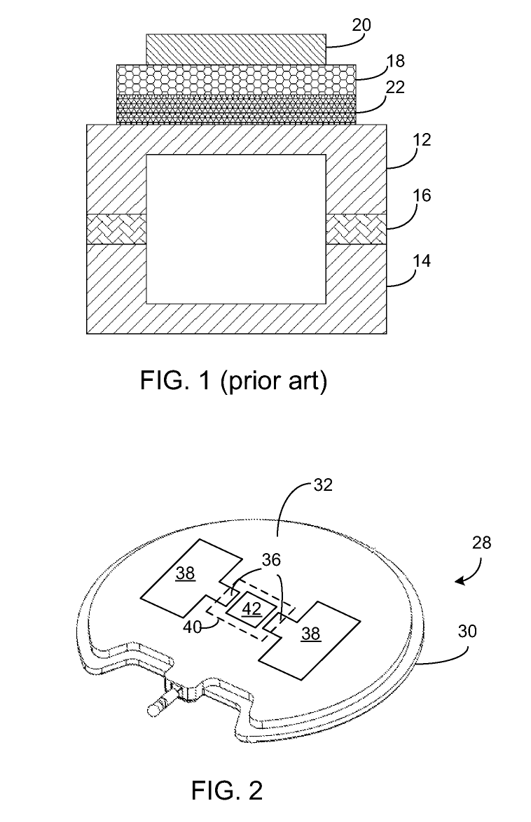

Elements labeled with the same numerals in the various figures are the same or equivalent.

### DETAILED DESCRIPTION

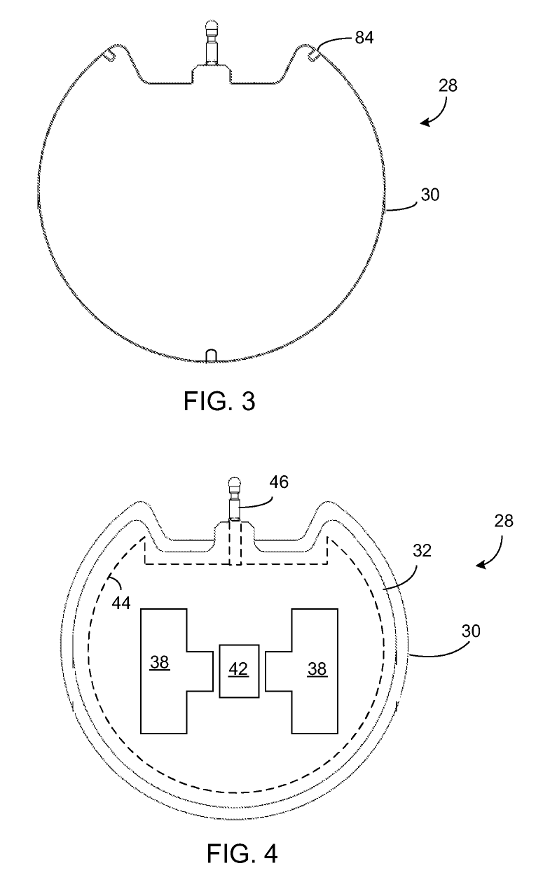

FIG. 2 is a top perspective view of a vapor chamber 28 formed in accordance with one embodiment of the invention. FIG. 3 is a back view of the vapor chamber 28 of FIG. 2, and FIG. 4 is a front view of the vapor chamber 28 of FIG. 2.

In the example, the bottom shell 30 of the vapor chamber 28 is formed of copper and has a depression surrounded by raised edges. The bottom shell 30 may be molded, stamped, forged, or formed in other suitable ways.

The top shell of the vapor chamber 28 is a circuit board 32. The circuit board 32 may be a flat circuit board or a circuit board with downward edges. The term “circuit board” includes boards with metallization patterns that interconnect multiple electrical components together or may just electrically couple a single electrical component to a power supply. The mating surfaces of the circuit board 32 and bottom shell 30 are metal, and the mating surfaces are diffusion bonded together under heat and pressure. The mating surfaces are first mechanically polished, if necessary, to provide uniform mating of the surfaces. (Additional details of diffusion bonding are provided later.) Accordingly, the bottom surface of the circuit board 32 is directly contacted by the liquid inside the vapor chamber 28 after the chamber 28 is filled with the working fluid (e.g., water). The vapor chamber 28 contains a conventional wick layer.

A patterned metal layer, forming metal portions 36, 38, and 42, is deposited over the circuit board 32 prior to diffusion bonding so that the metal layer can be formed using conventional techniques without handling of the vapor chamber 28. Additionally, forming the metal layer on the circuit board before the diffusion bonding enables any complex metal interconnection patterns to be tested for shorts or open circuits. If the circuit board fails, the circuit board is disposed of, rather than disposing of the more expensive vapor chamber.

Since a laminated or deposited dielectric layer should be avoided (to maximize thermal conductivity and avoid reliability problems), the insulating layer on the circuit board 32 is preferably an oxide of the metal core material. If the circuit board 32 is a ceramic core type, then no additional dielectric layer is needed.

In the simplified example of FIG. 2, the metal layer provides mounting pads 36 for a single device, such as an LED, where the mounting pads 36 are connected to larger metal pads 38 for connection to a power supply. The outline of the electrical device is shown in dashed outline 40. A thermal pad 42 is a metal piece, such as formed of copper, that may extend completely through the circuit board 32 to provide a high thermal conductivity vertical path. In another embodiment, the copper is formed in a blind hole so there is only a thin circuit board layer between the copper and the inside of the vapor chamber. Some LEDs and other devices have an electrically insulated thermal pad on their bottom surface for thermal coupling (e.g., soldering) to a heat sink, and that thermal pad is soldered to the pad 42.

The electrical device(s) may be coupled to the metal layer by soldering, ultrasonic welding, or any other suitable technique.

FIG. 4 illustrates the outer edge of the depression in the bottom shell 30 by a dashed line 44. The overlap of the raised edge of the bottom shell 30 and the back of the circuit board 32 are bonded together, preferably by diffusion bonding.

Since diffusion bonding may entail very high temperatures (slightly lower than the melting temperatures of the mating materials), and such heat is greater than the allowable heat for the working fluid, the working fluid may be introduced after the diffusion bonding. The fluid is introduced through a metal pipe 46 under a partial vacuum, and the pipe 46 is then crimped and cut to seal the vapor chamber 28.

The wick inside the vapor chamber may be a copper mesh, sintered metal beads, or other suitable wick for causing the working fluid to move to the heat source side by capillary action. The operation of vapor chambers is described in US Publication Nos. 2006/0196640, 2007/0295486, and 2008/0040925, and U.S. Pat. No. 7,098,486, all incorporated herein by reference.

FIG. 5 is a simplified, laterally compressed cross-sectional view of a vapor chamber 48, similar to that of FIG. 2, assuming that the circuit board 49 has downward edges (although the circuit board may instead be flat). A portion or all of the top surface of the circuit board 49 forms a dielectric layer. If the circuit board 49 has an aluminum core, the top surface may be masked and anodized to form portions of aluminum oxide that extend to any depth. The aluminum oxide is slightly porous and may be coated with a resin to seal it. However, the porosity of the aluminum oxide is beneficial for strongly bonding a copper layer that has been sputtered directly onto the oxide surface. Such an oxide layer will be substantially co-planar with the remainder of the aluminum core surface.

For anodizing portions of an aluminum core circuit board, the aluminum is masked using conventional lithography techniques. The exposed portions are anodized by immersing the aluminum in an electrolytic solution and applying current through the aluminum and the solution. Oxygen is released at the surface of the aluminum, producing an aluminum oxide layer having nanopores. The aluminum oxide layer may be formed to any depth. Aluminum oxide is ceramic in nature and is a highly insulating dielectric material with a thermal conductivity between 20-30 W/mk. The aluminum oxide layer can be made thin so as not to add significant thermal resistance. The unexposed aluminum circuit board has a very high thermal conductivity on the order of 250 W/mk.

A resin (a polyimide) may then be diffused into the porous aluminum oxide layer to planarize the surface.

The patterned metal layer 50, for later bonding to electrical components, may then be formed over the oxide portions. The metal layer 50 may be layers of Cu, Ni, and Au. If the circuit board 49 is ceramic, a dielectric layer is not needed, and the metal layer 50 can be printed on, sputtered, or otherwise directly bonded to the ceramic.

Plating a top copper circuit layer over an aluminum oxide layer in an aluminum core circuit board is sometimes described as an ALOX™ process. ALOX™ is a trade name coined by Micro Components, Ltd to identify an aluminum substrate with an oxidized surface portion and a copper layer (or other metal layer to aid soldering) deposited on the oxidized surface. Device Semiconductor Sdn. Bhd. (DSEM) is a licensee of the ALOX™ process. Forming ALOX™ substrates is described in US patent application publication US 2007/0080360 and PCT International Publication Number WO 2008/123766, both incorporated herein by reference.

In addition to all or some of the top surface of the vapor chamber being electrically insulating, an optional interface layer 51 may be used, such as a heat spreading layer. The layer 51 can also be a ceramic layer having a bottom metal layer that is bonded to the top of the circuit board 49. The layer 51 can be an aluminum core circuit board with dielectric layer portions formed by masking and anodizing the surface of the aluminum.

The metal layer 50 may be directly formed over the insulated circuit board 49 and/or on the interface layer 51.

The optional interface layer 51 may be initially bonded to the circuit board 49 by a solder layer, by diffusion bonding, or by other techniques. The interface layer 51 may be diffusion bonded at the same time that the circuit board 49 is diffusion bonded to the bottom shell 30.

FIG. 5 shows the circuit board 49 being diffusion bonded to the bottom shell by heat and pressure 52, creating a diffusion bonded mating area 54. Additional detail about diffusion bonding is provided below.

The melting point of copper is about 1084° C. The copper layers described herein include copper alloy layers whose melting points may differ from that of pure copper. The bottom shell and circuit board for forming the vapor chamber are placed in a vacuum chamber, and the temperature is raised to at least 700° C. The bottom shell and circuit board are then mechanically pressed together by a suitable press so that the mating copper surfaces experience a pressure of, for example, 500 psi (3.45 MPa) for diffusion bonding of the copper. The required temperature and/or pressure can be lower if the mating surfaces were coated with a metal from the Transition Group or Post Transition Group. Lower pressures along with higher temperatures may be used to achieve suitable diffusion bonding. After an appropriate time, there will be sufficient diffusion of atoms across the mating interface to form a bond essentially as strong as the bulk material with no discontinuities and no porosity.

After the diffusion bonding, the working fluid is introduced into the vapor chamber 48. The wick and fluid are indicated as numeral 55 in FIG. 5.

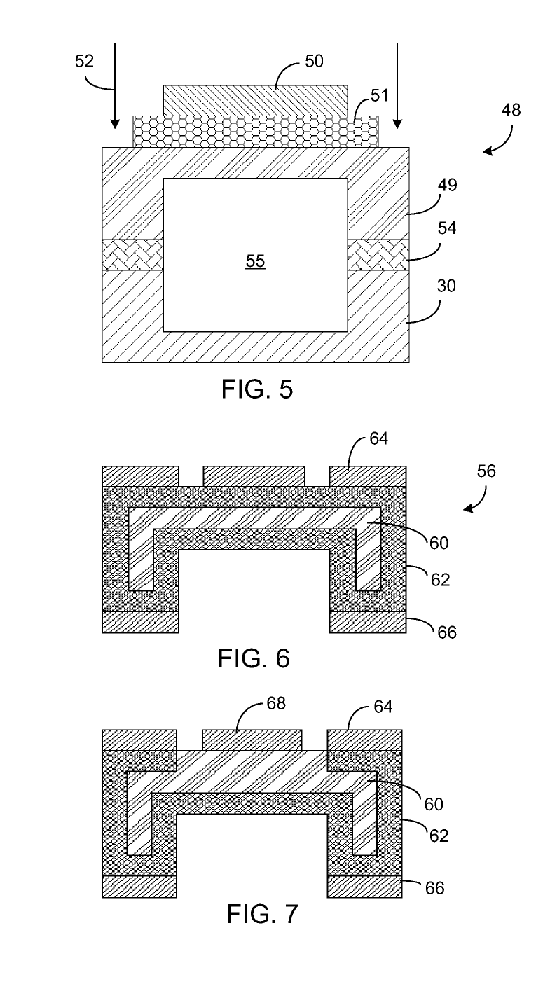

FIG. 6 is a cross-sectional view of a circuit board 56, similar to FIG. 2, where the circuit board 56 is an aluminum core 60 with its entire surface anodized to form a layer of electrically insulating aluminum oxide 62. The depth of the oxide 62 is greatly exaggerated for low voltage devices. A patterned metal layer 64 (e.g., copper) is formed on the top surface for interconnecting electrical components mounted on the top surface. The metal layer 64 may be formed by printing, sputtering, plating, or other technique.

The bottom mating edge 66 of the circuit board 56 is also coated with copper for diffusion bonding to the bottom shell 30 as in FIG. 5.

FIG. 7 is similar to FIG. 6 except there is no aluminum oxide under a metal pad 68. The metal pad 68 is a thermal pad for an electrical device (e.g., an LED) that may or may not be electrically insulated. Since aluminum is a much better thermal conductor than aluminum oxide, the structure of FIG. 7 provides improved through-plane thermal conductivity.

Since the top of the aluminum core is already insulated, anodizing the bottom of the circuit board in FIGS. 6 and 7 is optional.

The insulated surfaces in FIGS. 6 and 7 may instead be any passivated surface of any suitable metal (forming an oxide or nitride) and need not be aluminum oxide.

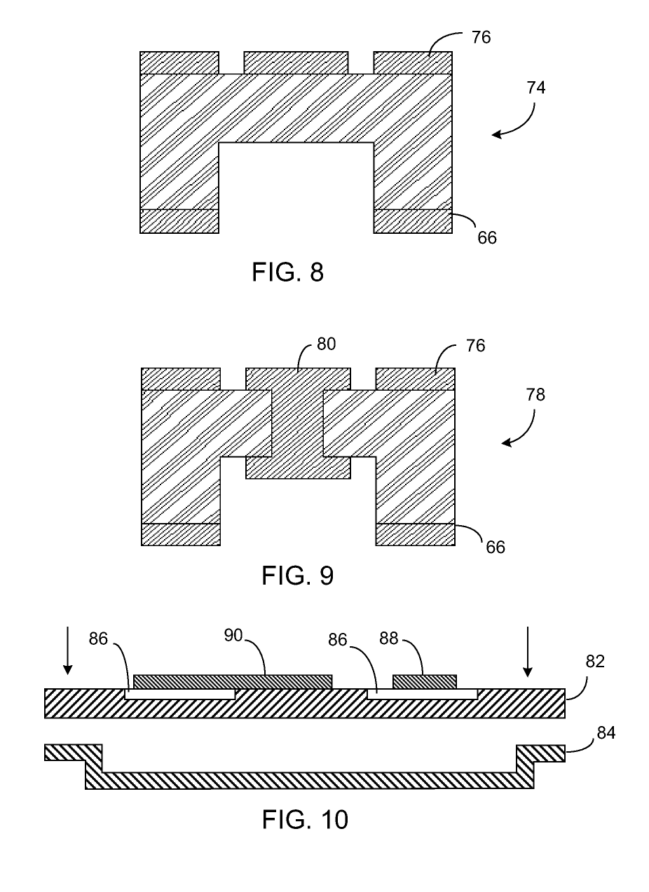

FIG. 8 is a cross-sectional view of a circuit board 74, similar to FIG. 2, where the circuit board 74 is formed of an insulating material such as a ceramic like Al₂O₃, AlN, BeO, or a special carbon material. The patterned metal layer 76 can be formed directly on the insulating material. Direct bonding of copper to a ceramic substrate is typically performed by pressing a copper foil against the ceramic surface and heating the structure to 1070° C. (close to the melting point of copper) in a pure N₂ atmosphere. After cooling, the copper foil is then etched to create the desired metal pattern. Copper is also deposited on the mating edges 66 of the ceramic.

Diffusion bonding the edges 66 of a metalized ceramic should be done at a high temperature and relatively low pressure due to the brittleness of ceramic.

FIG. 9 is similar to FIG. 8 but the circuit board 78 includes a through-hole filled with copper 80 to provide a high thermal conductivity path between the electrical device and the working fluid in the vapor chamber. The electrical device has a thermal pad directly bonded to the copper 80.

FIG. 10 is a cross-sectional view illustrating a flat circuit board 82 and a bottom portion 84 (having raised edges) formed of a different material, although the materials may be the same. For example, the bottom portion 84 may be copper and the circuit board 82 may be a composite material (either electrically conductive or insulating) designed to have a CTE similar to that of copper. For example, the circuit board 82 can be formed of aluminum silicon carbide (AlSiC) where the SiC fraction is adjusted to cause the AlSiC to have the same CTE as copper. Since AlSiC has a high thermal conductivity, both portions of the vapor chamber may be formed of this material.

Depending on the materials used, and any interface metal used, heat and pressure may be applied to diffusion bond the two portions, or the two halves are welded or bonded in other ways, to form a completed vapor chamber containing a wick and a fluid under a partial vacuum.

FIG. 10 also illustrates dielectric regions 86 formed by oxidation or other methods. A deposited and patterned metal layer (e.g., copper) forms two electrically isolated metal portions 88 and 90. Metal portion 88 is insulated from the circuit board 82 core. Metal portion 90 is deposited over a dielectric region 86 and directly on the thermally conductive circuit board core for improved heat sinking.

The vapor chamber may be any shape, including rectangular. In one embodiment, the vapor chamber is on the order of 3-5 mm thick and has a maximum size of 400×400 mm.

After the vapor chamber is formed, the working fluid is then introduced into the vapor chamber via the copper inlet pipe under a partial vacuum, and the pipe is then crimped and cut to seal the container. The structure is then shipped to the die manufacturer or assembler for attachment of the dies to the circuit board. The assembler does not need any special equipment for the die attachment. If solder reflow is to be used for die attachment, the working fluid may be introduced after die attachment. Preferably, the dies are flip-chips with all electrodes on the bottom of the dies so there are no wire bonds needed. This improves the thermal conductivity between the dies and the vapor chamber. The dies may be encapsulated on the circuit board.

In one embodiment, the metal core of the circuit board, forming the top portion of the vapor chamber, is not used to conduct electricity between components. This is advantageous since there is then no requirement to electrically insulate the bottom of the vapor chamber from a metal heat sink. Further, using the metal core as a conductor introduces various electrical concerns, including safety concerns. It is generally much better to use a patterned metal layer to perform all electrical interconnect functions.

If the circuit board is a metal core type, it is advantageous that the dielectric regions be substantially co-planar with the remainder of the surface, so that the insulated metal pads for electrical contact and the non-insulated metal thermal pads for thermal contact are co-planar, to simplify the mounting of surface mounted devices. For a ceramic core circuit board, such co-planar characteristics are inherent.

The heat sources may be any electronic device (e.g., a resistor) and not limited to dies.

Typically, the bottom surface of the vapor chamber is flat, and bolt holes or recesses are provided in flanges extending from the vapor chamber for mounting the bottom surface flush against a metal heat sink, such as a heat sink with fins. FIG. 3 shows bolt recesses 84. A squishable thermally conductive layer, such as a thermal grease, is typically applied between the vapor chamber and the heat sink to ensure complete thermal contact over the entire mating surfaces. Thermal grease is also referred to as thermal paste, thermal compound, and other names.

In one embodiment, both surfaces of the vapor chamber are circuit boards similar to any of the circuit boards described herein. One end of the vapor chamber may then be connected to an external heat sink, such as via a heat pipe. By using a heat pipe, heat flows away from the vapor chamber to create an efficient cooling system.

In one embodiment using a ceramic substrate, the entire back surface of the ceramic circuit board is coated with a copper layer for heat spreading and better thermal coupling to the working fluid.

It is preferred that the top portion and bottom portion of the vapor chamber be formed of materials that have compatable coefficients of thermal expansion (CTE), depending on the expected temperature variations, such as both being formed of aluminum, or both being formed of copper, or one or both of the portions being a composite material tuned to have matching CTEs. A metal interface layer may be employed as a buffer layer to mitigate effects of any CTE mismatching.

Accordingly, by using the present invention, there are high in-plane and through-plane thermal conductivity paths between the dies and the heat sink. Only metal, ceramic, and any oxide layer are between the heat source die and the working fluid.

Having described the invention in detail, those skilled in the art will appreciate that given the present disclosure, modifications may be made to the invention without departing from the spirit and inventive concepts described herein. Therefore, it is not intended that the scope of the invention be limited to the specific embodiments illustrated and described.

What is claimed is:

1. A vapor chamber comprising:
a bottom portion; and
a top portion, the bottom portion and top portion being bonded together to form a sealed chamber containing a working fluid and a wick;
the top portion being a circuit board having a bottom surface forming an inner wall of the vapor chamber, the circuit board having a top surface supporting a patterned metal layer, electrically insulated from the bottom portion of the vapor chamber without using a laminated dielectric layer, for electrical connection to one or more electrical devices.

2. The chamber of claim 1 wherein the top portion comprises aluminum, and at least a portion of the metal layer is formed over an oxidized region of the aluminum.

3. The chamber of claim 1 wherein the top portion comprises a ceramic.

4. The chamber of claim 1 wherein the bottom portion and the top portion comprise a metal.

5. The chamber of claim 1 wherein one or both of the top portion and bottom portion comprise a composite material.

6. The chamber of claim 1 wherein the top portion is substantially flat, and the bottom portion has edges that are bonded to the top portion.

7. The chamber of claim 1 wherein the top portion has downward edges that are bonded to the bottom portion.

8. The chamber of claim 1 wherein at least a portion of the metal layer on the top portion is formed over a dielectric region on the top portion.

9. The chamber of claim 1 wherein the top portion comprises a metal core, or a metal composite core, having a top surface with one or more dielectric regions electrically insulated from the metal core and one or more regions that are in electrical contact with the metal core, wherein at least a portion of the metal layer on the top portion is formed over one of the dielectric regions on the top portion and another portion of the metal layer is formed over one of the regions that are in electrical contact with the metal core.

10. The chamber of claim 1 wherein the top portion comprises a ceramic and the bottom portion comprises a metal, wherein the top portion has a metal coating on a mating area between the top portion and the bottom portion for bonding with the bottom portion.

11. The chamber of claim 1 wherein the top portion is formed of a base material, wherein the top portion has a hole filled with a material more thermally conductive than the base material of the top portion for use as a thermal pad for an electrical device.

12. The chamber of claim 11 wherein the base material of the top portion is ceramic and the material that fills the hole is a metal.

13. The chamber of claim 11 wherein the hole is a through-hole.

14. The chamber of claim 1 wherein the top portion is formed of a base material, a bottom surface of the base material being exposed to the fluid internal to the vapor chamber.

15. The chamber of claim 1 wherein the top portion is formed of a base material, a bottom surface of the base material being coated with a metal, wherein the metal is exposed to the fluid internal to the vapor chamber.

16. The chamber of claim 1 wherein the chamber has features for securing it to a heat sink.

17. The chamber of claim 1 wherein the chamber has a thickness of 5 mm or less.

18. The chamber of claim 1 wherein the top portion is bonded to the bottom portion by diffusion bonding using pressure.

19. The chamber of claim 1 further comprising one or more heat-generating electrical devices electrically and thermally connected to the metal layer.

20. The chamber of claim 19 wherein the one or more heat-generating electrical devices are flip-chips having all electrodes on a bottom surface that are directly bonded to the metal layer without wires.

21. The chamber of claim 1 wherein the metal layer comprises pads for electrical connections and one or more pads for thermal coupling an electrical device to the vapor chamber.

22. A method comprising:
providing a bottom portion of a vapor chamber;
providing a top portion of the vapor chamber;
forming a patterned metal layer on the top portion of the vapor chamber prior to the bottom portion and top portion being bonded together, at least portions of the metal layer overlying a dielectric material that is not a lamination, the metal layer being configured for being bonded to electrodes of one or more electrical devices mounted on the top portion; and
after the metal layer is formed, bonding peripheral portions of the bottom portion and the top portion together to create a vapor chamber, the vapor chamber forming a sealed chamber containing a wick and a working fluid, the top portion being a circuit board for the one or more electrical devices.

23. The method of claim 22 wherein the step of bonding peripheral portions of the bottom portion and the top portion together comprises diffusion bonding, wherein at least the peripheral portions of the bottom portion and top portion are heated and subjected to a pressure to diffusion bond the peripheral portions together.

24. The method of claim 22 wherein the top portion comprises aluminum, and at least a portion of the metal layer is formed over an oxidized region of the aluminum.

25. The method of claim 22 wherein the top portion comprises a ceramic.

26. The method of claim 22 wherein the bottom portion and the top portion comprise a metal, including a metal composite.

27. The method of claim 22 wherein the top portion is substantially flat, and the bottom portion has edges that are bonded to the top portion.

28. The method of claim 22 wherein the top portion has downward edges that are bonded to the bottom portion.

29. The method of claim 22 wherein at least a portion of the metal layer on the top portion is formed over a dielectric region on the top portion.

30. The method of claim 22 wherein the top portion comprises a metal core, or metal composite core, having a top surface with one or more dielectric regions electrically insulated from the metal core and one or more regions that are in electrical contact with the metal core, wherein at least a portion of the metal layer on the top portion is formed over one of the dielectric regions on the top portion and another portion of the metal layer is formed over one of the regions that are in electrical contact with the metal core.

31. The method of claim 22 wherein the metal layer comprises pads for electrical connections and one or more pads for thermal coupling an electrical device to the vapor chamber.
